(19) United States
(12) Patent Application Publication
(10) Pub. No.: US 2010/0115529 A1
(43) Pub. Date: May 6, 2010

(54) Memory management apparatus and method

(75) Inventors: Chae Seok Im, Suwon-si (KR); Shi Hwa Lee, Seoul (KR); Jeong Joon Yoo, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/385,260

(22) Filed: Apr. 2, 2009

(30) Foreign Application Priority Data
Nov. 5, 2008 (KR) 10-2008-0109236

(51) Int. Cl. G06F 9/46; G06F 12/00; G06F 12/02

(52) U.S. Cl. 718/107; 711/173; 718/102; 711/E12.001; 711/E12.002

(57) ABSTRACT

A memory management apparatus and a memory management method may divide an external memory area assigned to a task into a first area and a second area, and load data stored in the first area into an internal memory of a processor while the task is performed by the processor.

### CROSS-REFERENCE TO RELATED APPLICATIONS

This application claims the priority benefit of Korean Patent Application No. 10-2008-0109236, filed on Nov. 5, 2008, in the Korean Intellectual Property Office, the disclosure of which is incorporated herein by reference.

### BACKGROUND

1. Field

Exemplary embodiments relate to an apparatus and method for managing a memory, and more particularly, to an apparatus and method for managing an on-chip memory for multitasking.

2. Description of the Related Art

A processor may store information of a currently executing program or task for promptly performing the program. The on-chip memory may be of either a cache structure or a Scratch Pad Memory (SPM) structure.

The cache may include a tag that performs as an index of stored data, and whether the data is stored in the cache is determined by the tag.

SPM may be scheduled by the processor and may not include a separate tag.

As efficiency of the processor and complexity of an application program increases, a frequency of using a multitasking increases, the multitasking processing a plurality tasks in a single processor. Since storage space of the on-chip memory is relatively small, information related to the plurality of tasks may not be stored. Accordingly, when information related to a specific information is stored in the on-chip memory, it is required to backup previously stored task information to an external memory.

### SUMMARY

Exemplary embodiments may provide an apparatus for managing a memory, the apparatus including a first controlling unit to divide an external memory area assigned to a task into a first area and a second area, and a second controlling unit to load data stored in the first area into an internal memory in a processor while the task is performed by the processor.

Exemplary embodiments may also provide a memory management method, the method including dividing an external memory area assigned to a task into a first area and a second area, and loading data stored in the first area into an internal area of a processor while the task is performed by the processor.

Additional aspects of exemplary embodiments will be set forth in part in the description which follows and, in part, will be apparent from the description, or may be learned by practice of the disclosure.

### BRIEF DESCRIPTION OF THE DRAWINGS

These and/or other aspects of exemplary embodiments will become apparent and more readily appreciated from the following description, taken in conjunction with the accompanying drawings of which:

FIG. 1 illustrates a memory management apparatus according to exemplary embodiments;

FIG. 2 illustrates an internal memory and an external memory managed by the memory management apparatus of FIG. 1;

FIG. 3 illustrates an example of a first task area and a second task area divided by a first controlling unit of FIG. 1;

FIG. 4 illustrates an example of a Heap area of FIG. 3;

FIG. 5 illustrates an example of a Stack area of FIG. 3; and

FIG. 6 is an operational flowchart illustrating an example of a memory management method of the memory management apparatus of FIG. 1.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present disclosure by referring to the figures.

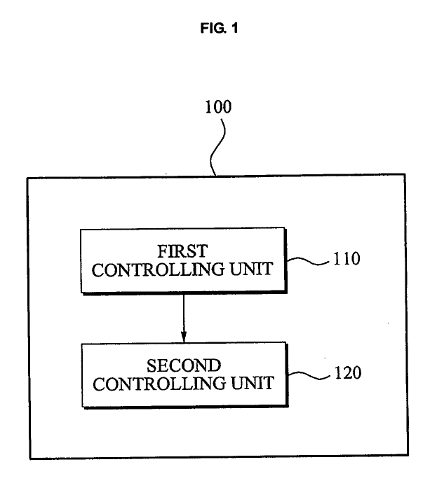

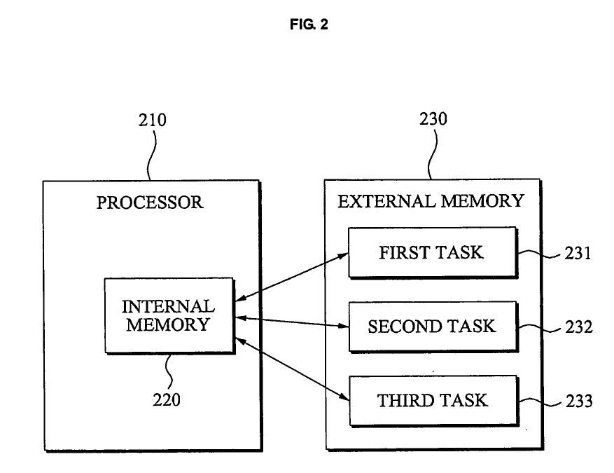

FIG. 1 illustrates a memory management apparatus 100 according to exemplary embodiments. FIG. 2 illustrates an internal memory (on-chip memory) 220 and an external memory 230 managed by the memory management apparatus 100 of FIG. 1.

The memory management apparatus 100 may include a first controlling unit 110 and a second controlling unit 120. The memory management apparatus 100 manages a main memory (external memory 230) outside of a processor 210 and the on-chip memory (internal memory 220) inside of the processor 210.

The first controlling unit 110 divides an external memory area of the external memory 230 assigned to a task into a first area and a second area.

The second controlling unit 120 loads data stored in the first area into the internal memory 220 while the task is performed by the processor 210.

The external memory area may be prepared for each of the plurality of tasks. That is, the external memory 230 may include a first task area 231 prepared for a first task and a second task area 232 prepared for a second task, and a third task area 233 prepared for the third task.

When the memory management apparatus 100 determines to load data related to the first task into the internal memory 220, the first controlling unit 110 divides the first task area 231 into a first area and a second area.

The second controlling unit 120 may load data stored in the first area into the internal memory 220, and may not access the second area.

When the processor 210 performs the second task instead of the first task, the first controlling unit 110 divides the second task area 232 into a third area and fourth area.

The second controlling unit 120 may load data stored in the third area into the internal memory 220, and may not access the fourth area. The memory management apparatus 100 may backup data stored in the internal memory 220 before loading the data stored in the third area.

The memory management apparatus 100 may select a data area copied between the internal memory 220 and the external memory 230 whenever a task performed in the processor 210 is changed. The memory management apparatus 100 may distinguish an area where backed up or loaded data is stored from an area prepared for the task, thereby decreasing an amount of data transmission between the internal memory 220 and the external memory 230. The memory management apparatus 100 may reduce a copy overhead between the internal memory 220 and the external memory 230.

The internal memory 220 may be either a cache structure or a Scratch Pad Memory (SPM) structure. When the internal memory 220 is the SPM, the processor 210 may recognize information, such as a size of data, a location of data, and the like, stored in the internal memory 220.

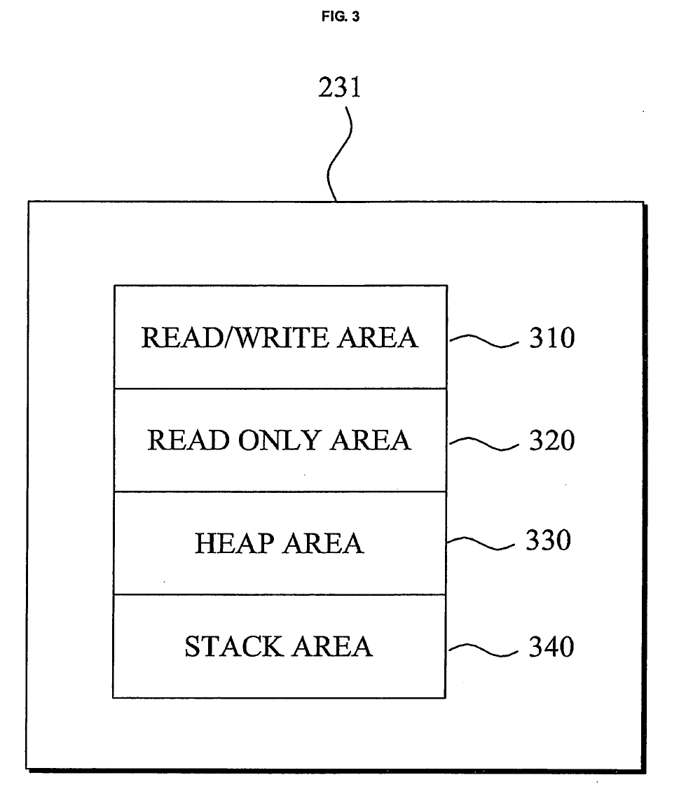

FIG. 3 illustrates an example of a first task area and a second task area divided by a first controlling unit of FIG. 1.

The first task area 231 may include a read/write area (RW area) 310, a read only area (RO area) 320, a Heap area 330, and a Stack area 340.

The RW area 310 is an area assigned to store data frequently changed while a first task is performed by the processor 210.

The RO area 320 is an area assigned to store data rarely changed while the first task is performed by the processor 210.

While the first task is performed by the processor 210, the memory management apparatus 100 may load data of the RW area 310 into an internal memory 220. The memory management apparatus 100 may or may not load data of the RO area 320 into the internal memory 220.

When the first task is a task relating to an encoding or decoding, data corresponding to an encoding or decoding algorithm may be classified into the RO area 320. The data corresponding to the algorithm is called a codebook, and also the corresponding data is data not changed while the first task is performed. Accordingly, when the first task is selected the memory management apparatus 100 may load data of the RO area 320 into the internal memory 220, and when a second task is selected instead of the first task, the memory management apparatus 100 may not need to backup data corresponding to the RO area 320 from among data stored in the internal memory 220, into the external memory 230.

When the first task is a task related to displaying, at least one of background image data, font data and character string data in association with the display may be classified into the RO area 320.

The Heap area 330 may be an area prepared for dynamic assignment of the first task, and the Stack area 340 may be an area prepared for a local variable of the first task.

The memory management apparatus 100 may designate a portion of the Heap area 330 and Stack area 340 and load a portion of the Heap area 330 and Stack area 340 into the internal memory 220.

When the second task is selected instead of the first task, the memory management apparatus 100 may backup only the loaded portion from among data of the internal memory 220, to the external memory 230.

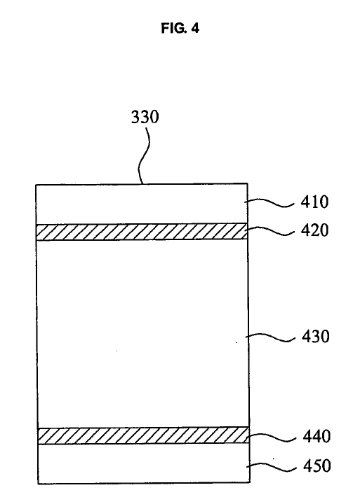

FIG. 4 illustrates an example of a Heap area of FIG. 3.

The Heap area 330 includes dynamically assigned areas 420 and 440 with respect to a first task, and includes non-dynamically assigned areas 410, 430, and 450.

A memory management apparatus 100 may load data of the dynamically assigned areas 420 and 440 into an internal memory 220, and may not load data of the non-dynamically assigned areas 410, 430, and 450.

When a second task is selected by a processor 210 and data of the first task is evicted from the internal memory 220, the memory management apparatus 100 may backup, to an external memory 230, only data corresponding to the areas 420 and 440 from among data of the internal memory 220.

The memory management apparatus 100 may manage information of the dynamically assigned areas 420 and 440 using a linked-list data structure.

As an example, a list A with respect to the area 420 may include a start address, a size of the area 420, and a pointer indicating a next list B.

The list B is a list storing information with respect to the area 440. The list B may include a start address of the area 440, a size of the area 440, and a pointer indicating a next list.

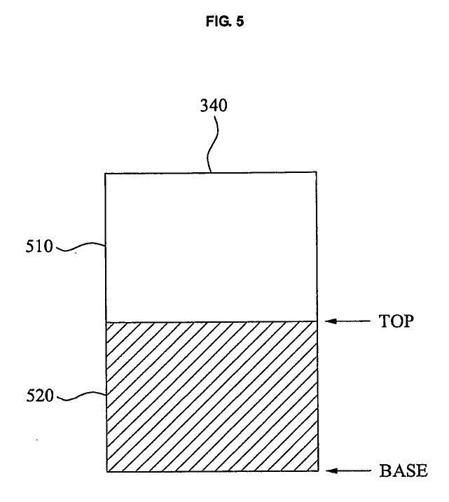

FIG. 5 illustrates an example of a Stack area of FIG. 3.

The Stack area 340 is an area prepared for a local variable of a first task.

A memory management apparatus 100 may manage the Stack area 340 using Stack data structure. The memory management apparatus 100 may distinguish an area 520 assigned for the local variable from an area 510 not assigned for the local variable, using a start location (Base) and end location of the Stack data structure.

The memory management apparatus 100 may load data stored in the area 520 into an internal memory 220, and may not load data of the area 510 into the internal memory 220.

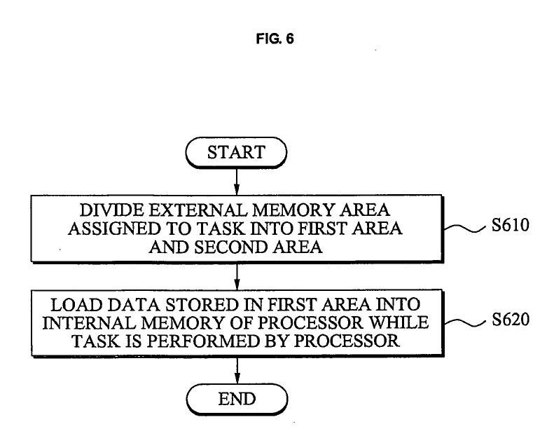

FIG. 6 is an operational flowchart illustrating an example of a memory management method of the memory management apparatus of FIG. 1.

The memory management apparatus 100 divides an external memory area of an external memory 230 assigned to a task into a first area and a second area in operation S610.

The memory management apparatus 100 loads data stored in the first area into an internal area 220 of a processor 210 while a task is performed by the processor 210 in operation S620.

The method according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Flash memory devices and/or memory controllers according to exemplary embodiments may be embodied using various types of packages. For example, the flash memory devices and/or memory controllers may be embodied using packages such as Package on Packages (PoPs), Ball Grid Arrays (BGAs), Chip Scale Packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Quad Flatpack (QFP), Plastic Metric Quad Flat Pack (MQFP), Thin Quad Flatpack (TQFP), Small Outline Integrated Circuit (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), and the like.

The flash memory devices and/or the memory controllers may constitute memory cards. In this case, the memory controllers may be constructed to communicate with an external device for example, a host using any one of various types of protocols such as a Universal Serial Bus (USB), a Multi Media Card (MMC), a Peripheral Component Interconnect-Express (PCI-E), Serial Advanced Technology Attachment (SATA), Parallel ATA (PATA), Small Computer System Interface (SCSI), Enhanced Small Device Interface (ESDI), and Integrated Drive Electronics (IDE).

The flash memory devices may be non-volatile memory devices that can maintain stored data even when power is cut off. According to an increase in the use of mobile devices such as a cellular phone, a personal digital assistant (PDA), a digital camera, a portable game console, and an MP3 player, the flash memory devices may be more widely used as data storage and code storage. The flash memory devices may be used in home applications such as a high definition television (HDTV), a digital video disk (DVD), a router, and a Global Positioning System (GPS).

A computing system according to exemplary embodiments may include a microprocessor that is electrically connected with a bus, a user interface, a modem such as a baseband chipset, a memory controller, and a flash memory device. The flash memory device may store N-bit data via the memory controller. The N-bit data is processed or will be processed by the microprocessor and N may be 1 or an integer greater than 1. When the computing system is a mobile apparatus, a battery may be additionally provided to supply operation voltage of the computing system.

It will be apparent to those of ordinary skill in the art that the computing system according to exemplary embodiments may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

Although a few exemplary embodiments have been shown and described, this disclosure is not limited to the described exemplary embodiments. Instead, it would be appreciated by those skilled in the art that changes may be made to these exemplary embodiments without departing from the principles and spirit of the disclosure, the scope of which is defined by the claims and their equivalents.

What is claimed is:

1. An apparatus for managing a memory, the apparatus comprising:
a first controlling unit to divide an external memory area assigned to a task into a first area and a second area; and
a second controlling unit to load data stored in the first area into an internal memory in a processor while the task is performed by the processor.

2. The apparatus of claim 1, wherein the second controlling unit does not access the second area while the task is performed by the processor.

3. The apparatus of claim 1, wherein:
the task is a first task;
the first controlling unit divides the external memory area assigned to a second task different from the first task into a third area and a fourth area, when the second task is selected by the processor; and
the second controlling unit loads data stored in the third area into the internal memory while the second task is performed by the processor.

4. The apparatus of claim 1, wherein the first controlling unit designates an area that stores data, the data being unchanged while the task is performed by the processor, as the second area.

5. The apparatus of claim 1, wherein the first controlling unit designates an area that stores data in association with an algorithm of the task when the task relates to an encoding or decoding, as the second area.

6. The apparatus of claim 1, wherein the first controlling unit designates an area that stores background image data, font data, or character string data in associated with the task when the task relates to a display, as the second area.

7. The apparatus of claim 1, wherein the first controlling unit designates an area that is dynamically assigned for the task as the first area, and designates an area that is not dynamically assigned for the task as the second area.

8. The apparatus of claim 1, wherein the first controlling unit designates an area that is assigned for a local variable of the task as the first area, and designates an area that is not assigned for the local variable of the task as the second area.

9. The apparatus of claim 8, wherein the first controlling unit manages the area assigned for the local variable of the task, using a stack structure, and designates the first area using a start location and end location of the stack structure.

10. The apparatus of claim 1, wherein the internal memory of the processor is a Scratch Pad Memory (SPM), and the first controlling unit stores index information with respect to data stored in the internal memory of the processor.

11. A memory management method, the method comprising:
dividing an external memory area assigned to a task into a first area and a second area; and
loading data stored in the first area into an internal area of a processor while the task is performed by the processor.

12. The method of claim 11, further comprising:
dividing the external memory area assigned to a second task into a third area and a fourth area when the second task different from the task is selected by the processor, wherein the task is a first task; and
loading data stored in the third area into an internal memory of the processor while the second task is performed by the processor.

13. The method of claim 11, wherein the dividing of the external memory area designates an area that stores data, the data being unchanged while the task is performed by the processor, as the second area.

14. The method of claim 11, wherein the dividing of the external memory area designates an area that stores data in association with an algorithm of the task when the task relates to an encoding or decoding, as the second area.

15. The method of claim 11, wherein the dividing of the external memory area designates an area that is dynamically assigned for the task as the first area, and designates an area that is not dynamically assigned for the task as the second area.

16. The method of claim 11, wherein the dividing of the external memory area manages the area assigned for a local variable of the task, using a stack structure, and designates the first area using a start location and end location of the stack structure.

17. A computer readable recording media storing a program to implement a memory management method, the method comprising:
dividing an external memory area assigned to a task into a first area and a second area; and
loading data stored in the first area into an internal area of the processor while the task is performed by the task.
